(19) United States
(12) Patent Application Publication
(10) Pub. No.: US 2007/0067485 A1
(43) Pub. Date: Mar. 22, 2007

(54) Method and system for managing video networks

(76) Inventors: Leonid Stotland, Jerusalem (IL); Ouri Azoulay, Jerusalem (IL)

Correspondence Address: Eitan Law Group;c/o Landon IP Inc., Suite 450, 1700 Diagonal Road, Alexandria, VA, 22314, US

(21) Appl. No.: 11/523,696

(22) Filed: Sep. 20, 2006

Related U.S. Application Data
(60) Provisional application No. 60/718,306, filed on Sep. 20, 2005.

(51) Int. Cl. G06F 15/16

(52) U.S. Cl. 709/232

(57) ABSTRACT

There is provided herein a real-time content transmitter comprising a bandwidth administration module adapted to regulate content transmission between the transmitter and one or more receivers, and to further regulate content retransmission from the one or more receivers. The transmitter may further include an encoding module adapted to encode content. The transmitter may further include a content transporter adapted to combine content streams in real time. There is also provided a real-time content receiver comprising communication module adapted to receive content from one or more sources based on a signal from a bandwidth administration module, the communication module further adapted to retransmit received content to one or more destinations based on a signal from a bandwidth administration module. The receiver may further include a content transporter adapted to combine content streams in real time. The receiver may further be adapted to send one or more acknowledge messages for received content to one or more transmitters.

### BACKGROUND

Streaming media is media that is consumed (heard or viewed), mostly in the form of clips, while it is being delivered. Streaming is more a property of the delivery system than the media itself. The distinction is usually applied to media that are distributed over computer networks. A media stream can be on demand or live. On demand streams are stored on a server for a long period of time, and are available to be transmitted at a user's request. Live streams are only available at one particular time, as in a video stream of a live sporting event.

Designing a network protocol to support streaming media raises many issues. Datagram protocols, such as the User Datagram Protocol (UDP), send the media stream as a series of small packets. This is simple and efficient; however, packets are liable to be lost or corrupted in transit. Depending on the protocol and the extent of the loss, the client may be able to recover the data with error correction techniques, may interpolate over the missing data, or may suffer a dropout.

The User Datagram Protocol (UDP) is one of the core protocols of the Internet protocol suite. Using UDP, programs on networked computers can send short messages sometimes known as datagrams to one another. UDP does not provide the reliability and ordering guarantees that TCP does. Datagrams may arrive out of order or go missing without notice. Without the overhead of checking if every packet actually arrived, UDP is faster and more efficient for many lightweight or time-sensitive purposes. Also, its stateless nature is useful for servers that answer small queries from huge numbers of clients. Compared to TCP, UDP is required for broadcast (send to all on local network) and multicast (send to all subscribers).

A protocol suite is a collection by layer of all protocols that implement that layer for any given reference model. The Internet protocol suite provides an example for the Internet reference model. The Internet protocol suite is the set of communications protocols that implement the protocol stack on which the Internet and most commercial networks run. It is sometimes called the TCP/IP protocol suite, after the two most important protocols in it; the Transmission Control Protocol (TCP) and the Internet Protocol (IP), which were also the first two defined.

The Internet Protocol (IP) is a data-oriented protocol used for communicating data across a packet-switched internetwork. IP is a network layer protocol in the internet protocol suite and is encapsulated in a data link layer protocol (for example, Ethernet). As a lower layer protocol, IP provides the service of communicable unique global addressing amongst computers. This implies that the data link layer need not provide this service. Ethernet provides globally unique addresses except it is not globally communicable

The Real Time Streaming Protocol (RTSP), Real-time Transport Protocol (RTP) and the Real-time Transport Control Protocol (RTCP) were specifically designed to stream media over networks. The latter two are built on top of UDP.

The Real Time Streaming Protocol (RTSP) is a protocol for use in streaming media systems which allows a client to remotely control a streaming media server, issuing VCR-like commands such as “play” and “pause”, and allowing time-based access to files on a server. The Real-time Transport Protocol (Or RTP) defines a standardized packet format for delivering audio and video over the Internet. RTCP stands for Real-time Transport Control Protocol, provides out-of-band control information for an RTP flow. It partners RTP in the delivery and packaging of multimedia data, but does not transport any data itself. It is used periodically to transmit control packets to participants in a streaming multimedia session. The primary function of RTCP is to provide feedback on the quality of service being provided by RTP.

Reliable protocols, such as the Transmission Control Protocol (TCP), guarantee correct delivery of each bit in the media stream. However, they accomplish this with a system of timeouts and retries, which makes them more complex to implement. It also means that when there is data loss on the network, the media stream stalls while the protocol handlers detect the loss and retransmit the missing data. Clients can minimize the effect of this by buffering data for display. Another issue is that firewalls are more likely to block UDP-based protocols than TCP-based protocols.

The Transmission Control Protocol (TCP) is a virtual circuit protocol that is one of the core protocols of the Internet protocol suite. Using TCP, applications on networked hosts can create connections to one another, over which they can exchange data in packets. The protocol guarantees reliable and in-order delivery of data from sender to receiver. TCP also distinguishes data for multiple connections by concurrent applications (for example, Web server and e-mail server) running on the same host.

Hypertext Transfer Protocol (HTTP) is a method used to transfer or convey information on the World Wide Web. Its original purpose was to provide a way to publish and retrieve HTML pages. Development of HTTP was coordinated by the World Wide Web Consortium and the Internet Engineering Task Force, culminating in the publication of a series of RFCs, most notably RFC 2616, which defines HTTP/1.1, the version of HTTP in common use today. HTTP is a request/response protocol between clients and servers. The originating client, such as a web browser, spider, or other end-user tool, is referred to as the user agent. The destination server, which stores or creates resources such as HTML files and images, is called the origin server. In between the user agent and origin server may be several intermediaries, such as proxies, gateways, and tunnels. An HTTP client initiates a request by establishing a Transmission Control Protocol (TCP) connection to a particular port on a remote host. An HTTP server listening on that port waits for the client to send a request message. Upon receiving the request, the server sends back a status line, and a message of its own, the body of which is perhaps the requested file, an error message, or some other information.

The Hyper Text Transport Protocol (Secure), or HTTPS, is the standard encrypted communication mechanism on the World Wide Web. HTTPS is a URL scheme which is syntactically identical to the http: scheme normally used for accessing resources using HTTP. Using an https: URL indicates that HTTP is to be used, but with a different default port and an additional encryption/authentication layer between HTTP and TCP. This system was developed by Netscape Communications Corporation to provide authentication and encrypted communication and is widely used on the World Wide Web for security-sensitive communication, such as payment transactions Unicast protocols send a separate copy of the media stream from the server to each client. This is simple, but can lead to massive duplication of data on the network. Multicast protocols undertake to send only one copy of the media stream over any given network connection, i.e. along the path between any two network routers. This is a more efficient use of network capacity, but it is much more complex to implement. Furthermore, multicast protocols must be implemented in the network routers, as well as the servers.

In computer networks, unicast is the sending of information packets to a single destination. “Unicast” is derived from the word broadcast, as unicast is the extreme opposite of broadcasting. In computer networking, multicasting is used to regain some of the efficiencies of broadcasting. These terms are also synonymous with streaming content providers' services. Unicast servers provide a stream to a single user at a time, while multicast servers can support a larger audience by serving content simultaneously to multiple users.

As of 2005, most routers on the Internet do not support multicast protocols, and many firewalls block them. Multicast is most practical for organizations that run their own networks, such as universities and corporations. Since they buy their own routers and run their own network links, they can decide if the cost and effort of supporting a multicast protocol is justified by the resulting bandwidth savings.

Peer-to-peer (P2P) protocols arrange for media to be sent from clients that already have them to clients that do not. This prevents the server and its network connections from becoming a bottleneck. However, it raises technical, performance, quality, business, and legal issues.

A peer-to-peer (or P2P) computer network is a network that relies primarily on the computing power and bandwidth of the participants in the network rather than concentrating it in a relatively low number of servers, P2P networks are typically used for connecting nodes via existing connections. Such networks are useful for many purposes. Sharing content files containing audio, video, data or anything in digital format is very common, and realtime data, such as telephony traffic, is also passed using P2P technology.

A pure peer-to-peer network does not have the notion of clients or servers, but only equal peer nodes that simultaneously function as both “clients” and “servers” to the other nodes on the network. This model of network arrangement differs from the client-server model where communication is usually to and from a central server. A typical example for a non peer-to-peer file transfer is an FTP server where the client and server programs are quite distinct, and the clients initiate the download/uploads and the servers react to and satisfy these requests.

FTP or file transfer protocol is a commonly used protocol for exchanging files over any network that supports the TCP/IP protocol (such as the Internet or an intranet). There are two computers involved in an FTP transfer: a server and a client. The FTP server, running FTP server software, listens on the network for connection requests from other computers. The client computer, running FTP client software, initiates a connection to the server. Once connected, the client can do a number of file manipulation operations such as uploading files to the server, download files from the server, rename or delete files on the server and so on.

One possible classification of peer-to-peer networks is according to their degree of centralization:

a. Pure peer-to-peer: Peers act as equals, merging the roles of clients and server. There is no central server managing the network and there is no central router

b. Hybrid peer-to-peer: Has a central server that keeps information on peers and responds to requests for that information. Peers are responsible for hosting available resources (as the central server does not have them), for letting the central server know what resources they want to share, and for making its shareable resources available to peers that request it. Route terminals are used addresses, which are referenced by a set of indices to obtain an absolute address.

An important goal in peer-to-peer networks is that all clients provide resources, including bandwidth, storage space, and computing power. Thus, as nodes arrive and demand on the system increases, the total capacity of the system also increases. This is not true of a client-server architecture with a fixed set of servers, in which adding more clients could mean slower data transfer for all users.

The distributed nature of peer-to-peer networks also increases robustness in case of failures by replicating data over multiple peers, and in pure P2P systems, by enabling peers to find the data without relying on a centralized index server. In the latter case, there is no single point of failure in the system.

Video hosting service allows individuals to upload video to an Internet website. The video host will then store the video on its server, and show the individual different types of code to allow others to view that video. Because many users do not have personal webspace, either as a paid service, or through an ISP offering, video hosting services are becoming increasingly popular as the demand for hosting services increases. The mass market for camera phones has increased the supply of consumer generated video. Traditional methods of consumer video distribution. Such as making a DVD to show to friends at home, are unsuited to the low resolution due to low bandwidth of telephone lines or the like, and high volume of source video, such as provided by camera phone clips and the like. In contrast, current broadband Internet connections are well suited for serving the quality of video shot on mobile phones. Most consumers do not own web servers, and this has created a demand for hosting consumer generated video content.

Video sharing refers to websites or software where a user can distribute their video content. Some services may charge, but the bulk of them offer free services. Many services have options for private sharing and other publishing options. Video sharing services can be essentially classified into two categories, central server distribution and peer-to-peer (P2P).

Central server distribution requires first the user to upload the video to a file server. Each user may be allocated a certain amount of space in the central server to host a video file. The video is then served to many viewers, employing streaming servers with technologies that are well known in the industry. This approach may be employed when consumers need to share short videos, where ownership of the media is not important, and where infrastructure costs are not important as well. In this approach usually the center checks and reviews the videos. The disadvantages of this method however are:

a. It takes time to upload a video to the centralized server, causing delays in the process;

b. There are issues of ownership and control over the data files by the owner of file. Once uploaded, the user may lose ownership over the content, and may have to forgo copyright over the content;

c. This method creates serious bottlenecks on the streaming servers when streaming to many users;

d. This method also has cost implication with the bandwidth required to stream to many users;

e. In this approach usually users may be limited by the length of the video transmitted;

f. The host may have policies as far as the content allowed resulting in delays in the review and approval cycles which may frustrate users who are waiting for their data files to be hosted.

Pure peer-to-peer distribution removes the need for a central server as required for central server distribution, but rather functions as a grid of personal computers communicating in a node-to-node fashion. The focal point behind this approach may be to reduce the load on the center from a cost and infrastructure perspectives. From a technical perspective this method may rely on processes of splitting a video file to multiple segments, with various sequencing and time stamping mechanisms. These segments are then “seeded” on various personal computers and from that point on they are transmitted and exchanged around the grid on demand. This method makes use of bandwidth resources of nodes on a grid to assist in the transmission of segments around the grid. Once all segments arrived to the destination nodes, and only then, they are assembled and sequenced so that the video file can be viewed. The advantages over the previous method are in the reduction of bottlenecks on the central servers. The disadvantages for this method however may be:

a. The receiving node, or the viewer in the case of a video transmission, has to wait until all the segments of the video have arrived before the video can be viewed. The files may be transmitted in segments, usually in a slow mode. Once the whole file is received only then it can be processed. Therefore, in the case of a video it may be viewed only when it is received in its entirety;

b. Here too the user does not have control over the video once transmitted. Many of the segments and sometimes the full file may be duplicated and stored on nodes around the grid for future transmission;

c. This method has had much criticism, because of its anonymous transmissions which may be the source of problems related to illegal file sharing.

Hybrid peer-to-peer is a variation of pure peer-to-peer and is based on streaming media from a central server with the help of the upload resources from the grid. When the server has enough bandwidth it streams to the nodes, and when bandwidth is limited, then the nodes receive the files in a download manner via the help of the grid. Systems of this nature may be employed in cases where individuals do not have the means to establish a strong server infrastructure for streaming. From a technical perspective this method may rely on seeding or hosting a file on a central server to serve the file to a first node. The first node than “serves” other nodes on a chain mode. The improvement over the central server distribution is in the reduction of bottleneck on the server, as well as cost reduction. The disadvantages of this method however maybe as follows:

a. There is still a need to upload a file before it is shared;

b. There may be an issue of control and ownership of the file since it is stored on a hosted central server;

c. The video maybe subject to contents review causing delays in distribution;

d. Viewing of the video may not be instantaneous in those circumstances where the server is busy and distribution must rely on the use of the grid;

e. Use of grid upload resources in the sending nodes may not be efficient due to limitations in the multipoint transmission mechanism.

A variation in video sharing services is based on a method for limited client-based streaming. This video sharing service relies on the sending node splitting the video file to segments and transmitting these segments in the proper order in the form of “streams” to the receiving nodes. It is used primarily in cases when communication is needed on a one-to-one fashion, for example, when a user is traveling and would like to stream to himself or herself media that is stored on a computer or a DVR at home. This video sharing service eliminates the need for a central server, the need for the video file uploading step, and the bottlenecks on the server. The disadvantage, however, may be that the communication makes use of available upload bandwidth of the sending node only. The transmission therefore is usually limited to a “one-to-one” mode or to very few viewers concurrently.

Another variation in video sharing services is based on combining the streams into a “burst” in a push mode primarily in the area of radio transmission from many sending antennas to many receiving antennas. From a technical perspective, segments from multiple senders may be added together before they are sent. Upon reception the segments are decoded so as to return to the original segment. The advantage is in making the transmission more efficient so that antennas receive data from multiple sources, especially when receiving nodes, such as radio receivers, are mobile and they have the need to receive data from multiple sources. The disadvantages of this method may be as follows:

a. The lack of use free upload bandwidth available in the receiving nodes.

b. The lack of attention to the elimination of duplicate packets since segments are always combined via an additive method, and no acknowledge mechanism of reception is implemented.

Data compression or source coding is the process of encoding information using fewer bits (or other information-bearing units) than an unencoded representation would use through use of specific encoding schemes. As is the case with any form of communication, compressed data communication only works when both the sender and receiver of the information understand the encoding scheme. Some compression algorithms exploit this property in order to encrypt data during the compression process so that decompression can only be achieved by an authorized party (such as may be through the use of a password or some other sort of registration procedure). Compression is useful because it helps reduce the consumption of expensive resources, such as memory space or transmission bandwidth. Compressed data must be uncompressed to be viewed (or heard).

Encoding video requires finding efficient coding formats for the video files. The video files usually not only contain visual information but also may have other contents, including audio, text, meta data and the like, video and audio imposing the greatest demands with regards to memory demand and transmission bandwidth. Therefore, the video and audio data may be compressed. Unfortunately, this can rarely be done without loss of quality (lossy compression is generally used where despite losses, the quality of the data is still useful after decompression), because of the enormous size of a lossless video stream. Video coding has two distinct goals, storing and transmission of video data. Almost all successful techniques developed for video coding have been integrated in the MPEG standards. Therefore, the MPEG standards represent a comprehensive knowledge base for video coding. Most video coding standards and commercial formats are modifications of MPEG.

The Moving Picture Experts Group or MPEG is a working group of ISO/IEC charged with the development of video and audio encoding standards. MPEG (pronounced EM-peg) has standardized the following compression formats and ancillary standards:

MPEG-1: Initial video and audio compression standard. Later used as the standard for Video CD, and includes the popular Layer 3 (MP3) audio compression format.

MPEG-2: Transport, video and audio standards for broadcast-quality television. Used for over-the-air digital television ATSC, DVB and ISDB, digital satellite TV services like Dish Network, digital cable television signals, and (with slight modifications) for DVDs.

MPEG-3: Originally designed for HDTV, but abandoned when it was discovered that MPEG-2 was sufficient for HDTV.

MPEG-4: Expands MPEG-1 to support video/audio “objects,” 3D content, low bitrate encoding and support for Digital Rights Management. Several new (newer than MPEG-2 Video) higher efficiency video standards are included (an alternative to MPEG-2 Video), notably, Advanced Simple Profile and Advanced Video Coding.

MPEG-7: A formal system for describing multimedia content.

MPEG-21: MPEG describes this future standard as a multimedia framework.

MPEG-8: A future system for describing multimedia content for Stug's personal enjoyment.

Lossy data compression method is one where compressing data and then decompressing it retrieves data that may well be different from the original, but is “close enough” to be useful in some way. Lossy data compression is used frequently on the Internet and especially in streaming media and telephony applications. These methods are typically referred to as codecs in this context. Most lossy data compression formats suffer from generation loss; repeatedly compressing and decompressing the file will cause it to progressively lose quality.

There are two basic lossy compression schemes. In lossy transform codecs, samples of picture or sound are taken, chopped into small segments, transformed into a new basis space, and quantized. The resulting quantized values are then entropy coded. In lossy predictive codecs, previous and/or subsequent decoded data is used to predict the current sound sample or image frame. The error between the predicted data and the real data, together with any extra information needed to reproduce the prediction, is then quantized and coded. In some systems the two techniques are combined, with transform codecs being used to compress the error signals generated by the predictive stage.

The advantage of lossy methods over lossless methods is that in some cases a lossy method can produce a much smaller compressed file than any known lossless method, while still meeting the requirements of the application. Lossy methods are most often used for compressing sound, images or videos. The compression ratio (that is, the size of the compressed file compared to that of the uncompressed file) of lossy video codecs are nearly always far superior to those of the audio and still-image equivalents. Audio can be compressed at 10:1 with no noticeable loss of quality, video can be compressed immensely with little visible quality loss, for example, 300:1. Lossily compressed still images are often compressed to 1/10th their original size, as with audio, but the quality loss is more noticeable, especially on closer inspection. When a user acquires a lossily-compressed file, (for example, to reduce download-time) the retrieved file can be quite different from the original at the bit level while being indistinguishable to the human ear or eye for most practical purposes. Many methods focus on the idiosyncrasies of the human anatomy, talking into account, for example, that the human eye can see only certain frequencies of light. The psychoacoustic model describes how sound can be highly compressed without degrading the perceived quality of the sound.

Many techniques and systems exist today for video file sharing and viewing. Nevertheless, transmission of high quality long video files in real time via the Internet still remains a challenge today. The problem is particularly highlighted for video when it wants to be viewed in an instantaneous, real-time mode, with minimal delay and jitters, due to limited upload and download transmission resources in nodes, such as PC's. There is therefore a need for a system and a method, which will permit administration and maximum possible utilization of the upload and download transmission resources of the nodes in a video network, and thereby allow viewing of realtime streaming media.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

In one embodiment, there is provided a real-time content transmitter comprising a bandwidth administration module adapted to regulate content transmission between the transmitter and one or more receivers, and to further regulate content retransmission from the one or more receivers. The transmitter may further include an encoding module adapted to encode content. The transmitter may further include a content transporter adapted to combine content streams in real time.

In another embodiment, there is provided a real-time content receiver comprising communication module adapted to receive content from one or more sources based on a signal from a bandwidth administration module, the communication module further adapted to retransmit received content to one or more destinations based on a signal from a bandwidth administration module. The receiver may further include a content transporter adapted to combine content streams in real time. The receiver may further be adapted to send one or more acknowledge messages for received content to one or more transmitters.

The bandwidth administration module may be adapted to regulate content transmission and retransmission such that content data rates are at or above a minimum data rate associated with the content. The bandwidth administration module may be adapted to calculate dynamic bandwidth. The bandwidth administration module may be adapted to instruct one ore more nodes to communicate at a calculated speed. The bandwidth administration module may be adapted to assign one or more nodes to send data. The bandwidth administration module may be adapted to assign one or more nodes to send data based on available communication options between two or more nodes.

The content may include media content. The media content may include video content. The bandwidth administration module may be transferable to another node. The bandwidth administration module may be adapted to identify a disabled node and to assign another node to send or receive data. The bandwidth administration module may be adapted to establish a transit node when there are limitations imposed by firewall. The bandwidth administration module may be adapted to regulate content transmission between the transmitter and one or more receivers without uploading the content to a central server.

### BRIEF DESCRIPTION OF THE DRAWINGS

Exemplary embodiments are illustrated in referenced figures and drawings. It is intended that the embodiments and figures disclosed herein are to be considered illustrative rather than restrictive.

FIG. 1 illustrates an exemplary system architecture of the video file data transfer system;

FIG. 2 illustrates an exemplary schematic diagram of the object model of an embodiment of the present disclosure;

FIG. 3A illustrates an exemplary structural configuration of an exemplary video network for real-time content transmission of video;

FIG. 3B illustrates an analogous topological configuration for an exemplary transport system described by the exemplary video network in FIG. 3A;

FIG. 4 illustrates exemplary topological maps showing combinations of managerial and functional interrelationships in a video management and transport system;

FIG. 5 illustrates exemplary topological maps of the transport system for an embodiment of the present disclosure;

FIG. 6 illustrates a flow chart of an exemplary process of building a video network;

FIG. 7 illustrates two exemplary transport methods depending on the state of the video network;

FIG. 8 illustrates an exemplary process of bandwidth administration and utilization for an embodiment of the present disclosure;

FIG. 9 illustrates an exemplary video network and the process of merging two streams in real-time into one stream;

FIG. 10 shows a flow diagram of the decision making process involved in sending data to a receiver.

FIG. 11 illustrates a flow diagram of the process used by the linear combination solver;

FIG. 12 illustrates an exemplary video network with a non-combinatorial streaming configuration;

FIG. 13 illustrates an exemplary video network with a combinatorial streaming configuration.

### DETAILED DESCRIPTION

This disclosure relates to the real-time transmission of content over a data communications network, particularly video content, where there are many senders and receivers of high quantities of data, and where the data must arrive in the proper order and timing. Furthermore, this disclosure relates to techniques for bandwidth administration for those cases where there are limited resources in terms of the upload bandwidth of each sender and the download bandwidth of each receiver, and where a certain host of a data file may transmit the data with help from other nodes that have received portions of the data file.

1. System Architecture

The system architecture disclosed in this embodiment includes the following elements and components identified and described herein:

a. Channel—a communication line that connects two nodes. Channels allow transferring or transporting of video files from one node to another. The channel may be any wired or wireless line.

b. Data—an ordered collection of bits that represent text, images, audio, video or other information in any format.

c. Manager component—one or more software component(s), feature(s), or function(s) with management functions for the video network. They manage(s) one or more virtual video library(ies), as well as the transport or transmission between video transporters in its network or networks. The manager component performs bandwidth administration and decides what devices or functions send data to others and at what speed.

d. Manager—a node which contains a manager component. The term Manager and Manager component may be used interchangeably in this disclosure.

e. Node—may be a PC, server, mobile phone, handheld device or other computer or communication unit. A node may contain a manager component or a video transporter or both. A node also may include any industry standard component such as video encoders and players.

f. Projector—a node that hosts a video and transmits it to other nodes.

g. Receiver—a node that receives data.

h. Sender—a node that sends data.

i. Transmitter—same as a sender; the term may be used interchangeably with Sender.

j. Video network—a collection of nodes and channels in which data is being transmitted. A video network manages one video file and handles its transport.

k. Video transporter (VT)—a software component that resides on the nodes and is responsible for sending and/or receiving data. A video transporter is also used for projection and viewing. The video transporter may participate in many video networks.

l. Virtual video library—a list, database or index of all the video files hosted on various video transporters in the video network. This library may be hosted and managed by the manager.

m. Viewer—a video transporter that acts as a viewer of a video.

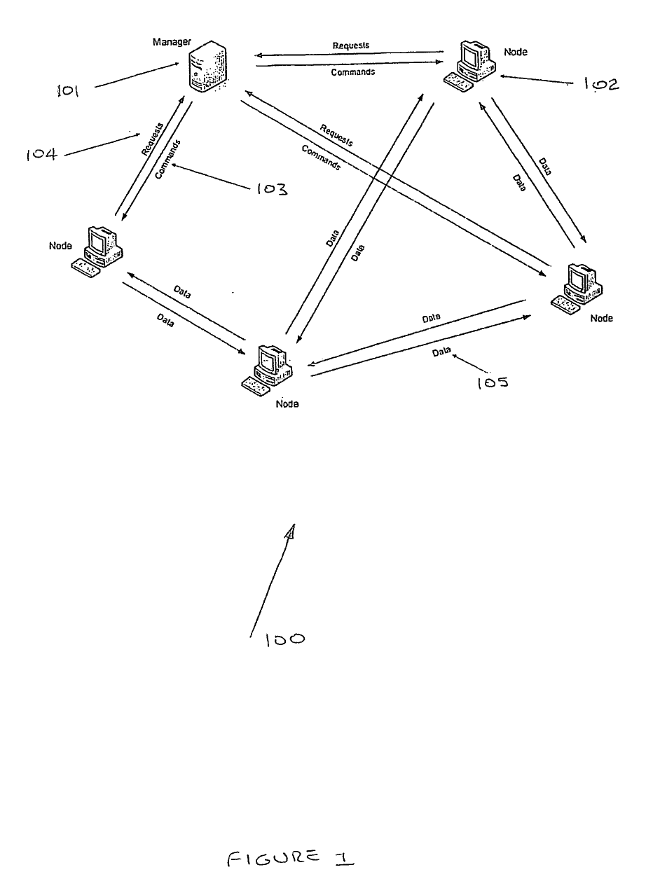

Reference is made to FIG. 1 which is an illustration of an exemplary system architecture of a video network (100) for real-time content transmission of video which includes a Manager (101) and four nodes (102), although in other embodiments the video network may consist of one Manager (101) and only one node (102), or one Manager (101) and any multiplicity of nodes (102).

The video network (100) is made up of nodes (102). A node (102) may be a Manager (101), in which case it contains a Manager component, or it can be simple node (102), in which case it contains a video transporter. Each video network (100) is built specifically for a particular video file and is managed by only one Manager (101), although a node (102) is capable of participating in several video networks (100), each video network (100) having its own Manager (101). A Manager (101) can manage several video networks (100).

The Manager (101) is responsible for the management of the video network (100), deciding which node (102) acts as a sender, to whom it sends the data (105), and the speed at which the data (105) is to be sent. The Manager (101) essentially controls the state of the video transporter in each node (102), sending them commands (103) such that every sender knows initial information about the data (105) which is to be sent, including the receiver's address, and also sending the receivers information related to the incoming channels.

Each node (102) in the video network (100) is responsible for deciding what data (105) to send to another node (102) and how to send it, and is also responsible for requesting data (105) from other nodes (102). Each node (102) can also send and receive data (105) from other nodes in other video networks. Each node (102) contains a video transporter responsible for sending and receiving data (105) to and from other video transporters.

A node (102) can be a host for many files. A receiver requesting a certain file or several files sends a request (104) to the Manager (101), who is responsible for identifying those nodes available for data transmission and for communicating this information to the receiver. The receiver and senders are then responsible for communicating directly among themselves.

Flexibility in node functionality provides for improvements in system performance. A node (102), which acts as an original host can be replaced by one or more nodes (102) readily disposed to act as a host should the requirement arise. If a channel between two nodes (102) cannot be built, as may occur when firewalls are used at both nodes for example, a third node (102), or more nodes (102), can serve as intermediate video transporter. Two or more nodes (102) in the same video network (100) can act as hosts by simultaneously transmitting the same video file so it is seen in real time.

The connection means in the video network (100) among the nodes (102), and between the nodes (102) and the Manager (101), are based on standardized internet protocols, for example, such as TCP/IP, UDP, HTTP, HTTPS for internet connections. For those cases where the Manager (101) and the video transporter are on the same node (102) a local connection may be sufficient. For those cases where the video network (100) is on a local network, a local network protocol may be sufficient.

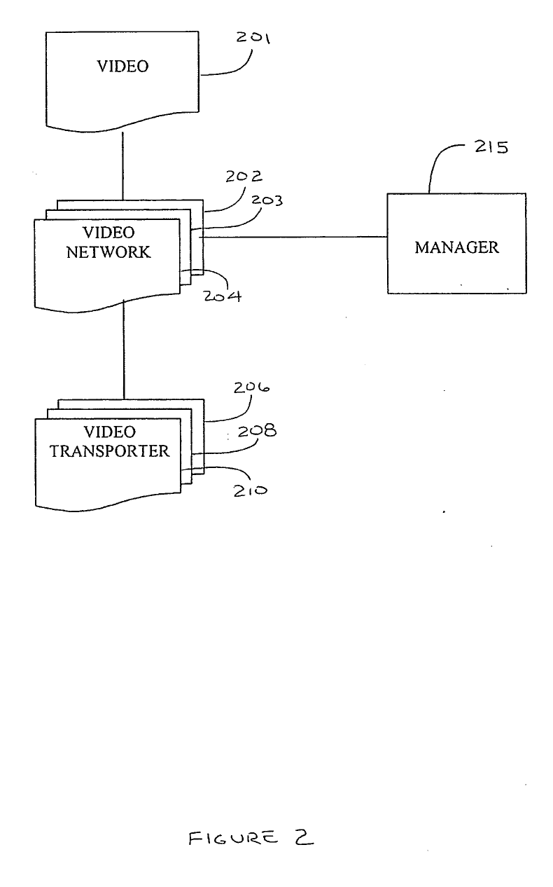

Reference is made to FIG. 2 which is a exemplary schematic diagram showing the object model of the present embodiment, and the interrelationship of the object elements in a system for managing video networks and for transporting video files. The example is for illustration purposes only and is not intended to be limiting as to the number of object elements which may interrelate in the system which may be of several orders of magnitude.

A video (201) can only participate in one and only one video network, for example, video network (202). A video network (202) is for one and only one video (201). A manager (215) manages one video network, for example, video network (202), but can simultaneously manage a multiple number of video networks, as is represented herein, for example, by the inclusion of either one or both video networks (203) and (204). A video network, for example, video network (202) is managed by only one manager (215). A video network, for example video network (202) contains one or multiple video transporters as is represented herein , for example, by the inclusion of either one, two or three video transporters (206), (208), and (210). A video transporter, for example, video transporter (206) may belong to one video network, for example video network (206), but may also belong to multiple video networks, as is represented herein, for example, by the inclusion of video transporters (208) and (210).

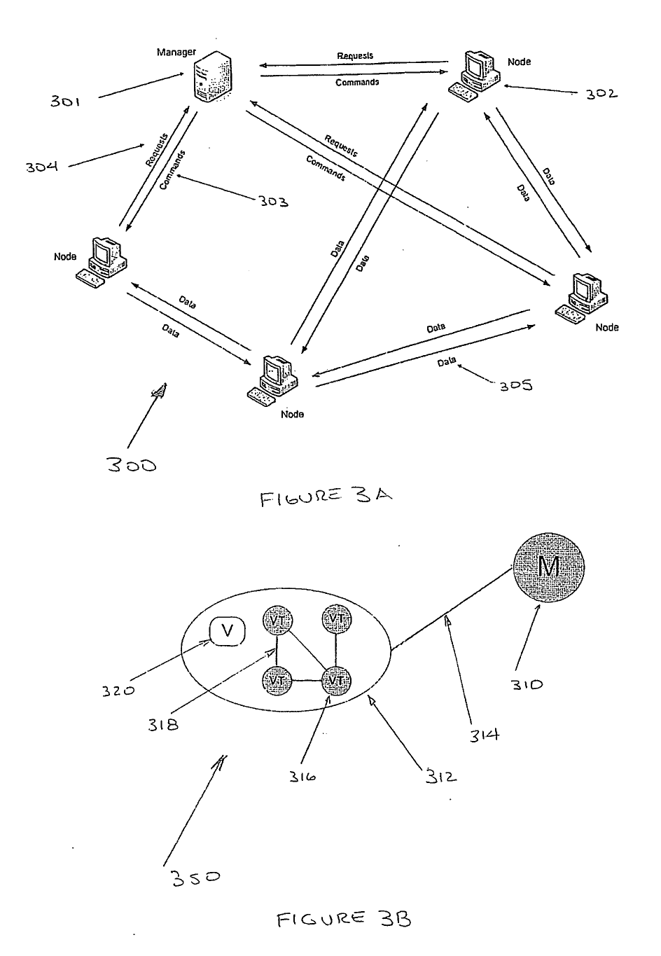

Reference is made to FIG. 3A which illustrates an exemplary structural configuration of an exemplary video network (300) for real-time content transmission of video, and to FIG. 3B which illustrates an analogous topological configuration for an exemplary transport system (350) described by the exemplary video network (300). The examples described herein are not intended to be limiting, such that other embodiments may include a video network and/or transport system which include one or a plurality of nodes and/or video transporters, for example 1-5, 5-25, 25-100, 100-1000, 1000-10000, 10000-100000, 100000-500000, 500000-1000000, 1000000-5000000.

The exemplary structural configuration refers to a video network (300) which includes four nodes (302), a Manager (301), command channels (303), request channels (304), and data channels (305), all of which may be similar to that shown in FIG. 1 at (100), (102), (101), (103), (104), and (105) The analogous exemplary topological configuration refers to a transport system (350) made up of four video transporters (316), a Manager component (310), a command/request transport layer (314) between the Manager component and the video network (316), and an intra-network file transport layer (318) shared by the video transponders (316).

The Manager component (310) is contained in the Manager (301) which can only occupy one node (302) in the video network (300). The video transporters (316), four in this example, are contained in the four nodes (302) in the video network (300). Each video network (312) is built specifically for a particular video file (320) and is managed by only one Manager component (310),

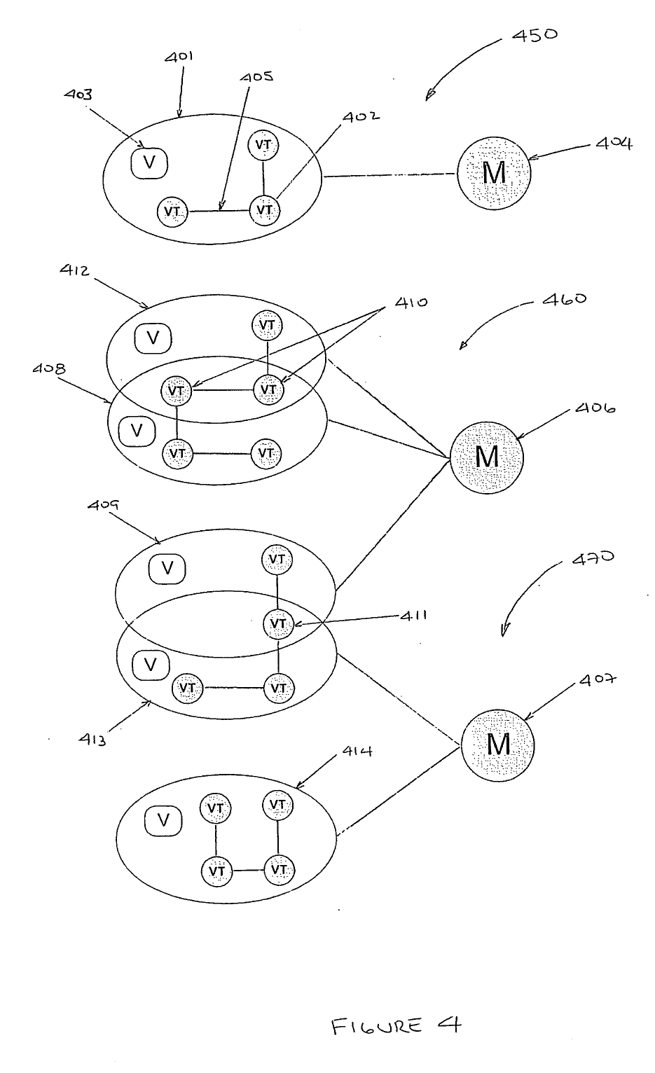

Reference is made to FIG. 4 which includes several topological maps showing examples of combinations of managerial and functional interrelationships between the various types of elements in a video management and transport system. A video management and transport system, hereinafter referred to as system, includes a Manager component, video transporter(s), video network(s), transport layer(s), which may hereinafter be used interchangeably with channel(s), and video file(s). The examples described herein are not intended to be limiting, and are only a small sample of the numerous combinations of managerial and functional interrelationships which are possible and to the number of elements which can be managed in one or more systems. Additionally, the above mentioned elements used in the illustrated examples may be similar, or even the same, for all of the examples, and may be similar or the same as those which may be used in the numerous possible combinations of interrelationships in one or more transport systems.

System (450) is an exemplary system wherein a Manager (404) manages one video network, for example video network (401), one video file is transported per video network, for example video file (403), and multiple video transporters participating within one video network, for example three video transporters, such as video transporter (402). Channel (405) is an example of a channel carrying data and control signals between the multiple video transporters, such as video transporter (402).

System (460) is an exemplary system wherein a Manager (406) manages multiple video network, for example three video networks, such as video network (412), video network (408) and video network (409), and multiple video transporters participating in multiple video networks, for example, two video transporters (410) participating in both video networks, video network (408) and video network (412).

System (470) is a variation of exemplary system (450) and system (460) wherein a Manager (407) manages multiple video networks, for example two video networks, such as video network (413) and video network (414), and multiple video transporters participate in multiple video networks , for example, one video transporter (411) participates in two video networks, video network (409) and video network (413), In this variation, the multiple video transporters participating in the multiple video networks are each managed by the individual Managers of each of the video networks, for example, video transporter (411) is managed by two Managers, Manager (406) and Manager (407).

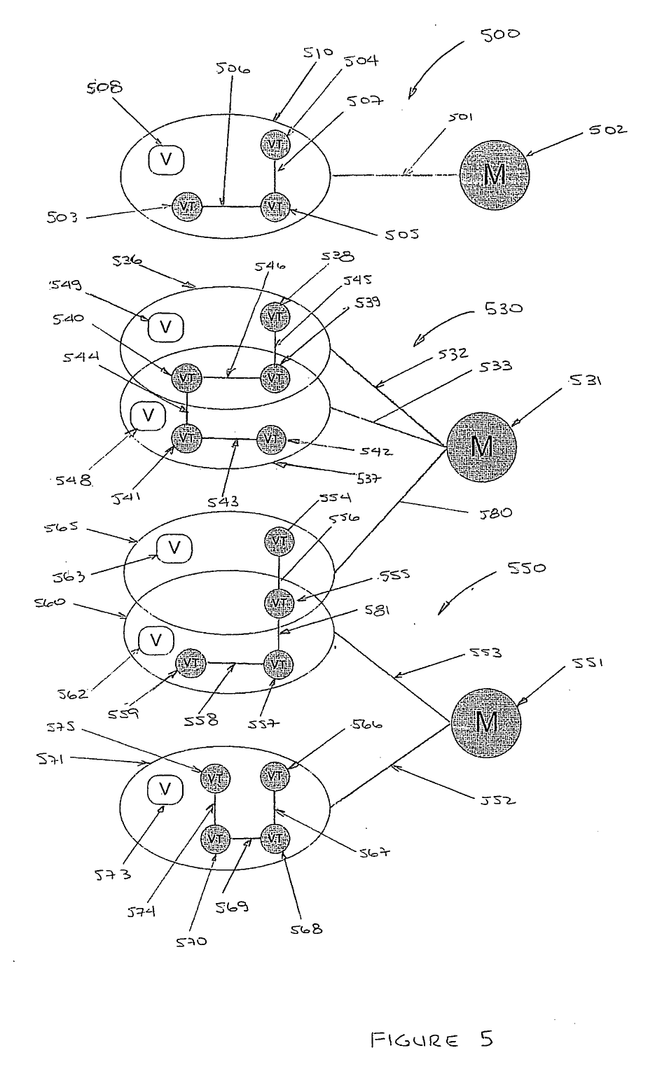

Reference is made to FIG. 5 which illustrates several topological maps of a transport system with examples of possible combinations of interconnections among various elements participating in such transport system(s), including the Manager component(s), the video transporter(s), the video network(s), and transport layer(s). The examples described herein are not intended to be limiting, and are only a small sample of the numerous combinations of interconnections which are possible and to the number of elements which can be interconnected in one or more transport systems. Additionally, the above mentioned elements used in the illustrated examples may be similar, or even the same, for all of the examples, and may be similar or the same as those which may be used in the numerous possible combinations of interconnections in one or more transport systems.

Transport system (500) is an example of one video network (510) managed by one Manager component (502). Command data is sent through transport layer (501), which may be similar to or the same as transport layers (506, 507), which may all be similar or the same transport layer, from the Manager component (502) to video transporters (503, 504, 505) in video network (510), and requests received from the video transporters (503, 504, 505) through transport layer (501). Video (508) may be projected by any one of the video transporters (503, 504, 505), for example video transporter (503), and is transmitted to video transporter (504) through transport layer (506), who retransmits video (508) to video transporter (504) through transport layer (507).

Transport system (530) is an example of three video networks (536, 537, 565) managed by one manager component (531) where some video transporters, for example two video transporter (539, 540), participate in more than one video network, for example two video networks (536, 537). In video network (536) command data is sent through a transport layer (532), which may be similar to or the same as transport layers (545, 546), which may all be similar or the same transport layer, from the Manager component (531) to video transporters (538, 539, 540), and requests are received from the video transporter (538, 539, 540) through transport layer (532). Video (549) may be projected by any one of the video transporters (538, 539, 540), for example video transporter (538), and is transmitted to video transporter (539) through transport layer (545), who retransmits video (549) to video transporter (540) through transport layer (546).

In video network (537) command data is sent through a transport layer (533), which may be similar to or the same as transport layers (543, 544, 546), which may all be similar or the same transport layer, from the Manager component (531) to video transporter (539, 540, 541, 542), and requests are received from the video transporter (539, 540, 541, 542) through transport layer (533). Video (548) may be projected by any one of the video transporters (539, 540, 541, 542), for example video transporter (539), and is transmitted to video transporter (540) through transport layer (546), who retransmits video (548) to video transporter (541) through transport layer (544), who retransmits video (548) to video transporter (542) through transport layer (543).

In video network (565) command data is sent through a transport layer (580), which may be similar to or the same as transport layer (556), which may all be similar or the same transport layer, from the Manager component (531) to video transporter (554, 555), and requests are received from the video transporter (554, 555) through transport layer (580). Video (565) may be projected by any one of the video transporters (554, 555), for example video transporter (554), and is transmitted to video transporter (555) through transport layer (556).

Although the two video networks, video network (536) and video network (537), share video transporter (539) and video transporter (540), which are essentially similar or the same to all the video transporters used in both video networks, and share a common transport layer (546), which is essentially similar or the same as all the other transport layers used in both video networks, video (549) is only projected, transported, and viewed by those video transporters associated with video network (536), while video projector (548)) is only projected, transported, and viewed by those video transporters associated with video network (537).

Transport system (550) is an example of two video networks (560, 571) managed by one manager component (551) where some video transporters, for example one video transporter (555), participate in more than one video network, for example two video networks (560, 565), and the third video network (571) is completely independent of the two other video networks (560, 565). In video network (560) command data is sent through transport layer (553), which may be similar to or the same as transport layers (558, 581), which may all be similar or the same transport layer, from the Manager component (551) to video transporters (555, 557, 559) and requests are received from the video transporters (555, 557, 559) through transport layer (553). Video (562) may be projected by any one of the video transporters (555, 557, 559), for example video transporter (557), and is transmitted to video transporter (555) through transport layer (581), and also to video transporter (559) through transport layer (558).

In video network (571), which is completely independent of video network (260), command data is sent through transport layer (552), which may be similar to or the same as transport layer (567, 569, 574), which may all be similar or the same transport layer, from the Manager component (551) to video transporter (566, 568, 570, 575), and requests are received from the video transporter (566, 568, 570, 575) through transport layer (552). Video (573) may be projected by any one of the video transporters (566, 568, 570, 575), for example video transporter (568), and is transmitted to video transporter (566) through transport layer (567), and also to video transporter (570) through transport layer (569) who then retransmits video (573) to video transporter (575) through transport layer (574).

Video transporter (555), which is included in both video network (565) and video network (560) may be managed by both Manager component (531) and Manager component (551).

2. Building the Video Network

The system requires building a video network wherein the video transporters are readily able to locate the Manager of the network. A centralized database or some other form of data storage means, which may also be distributed across multiple nodes, is used wherein are registered the identification details of the Manager and the nodes.

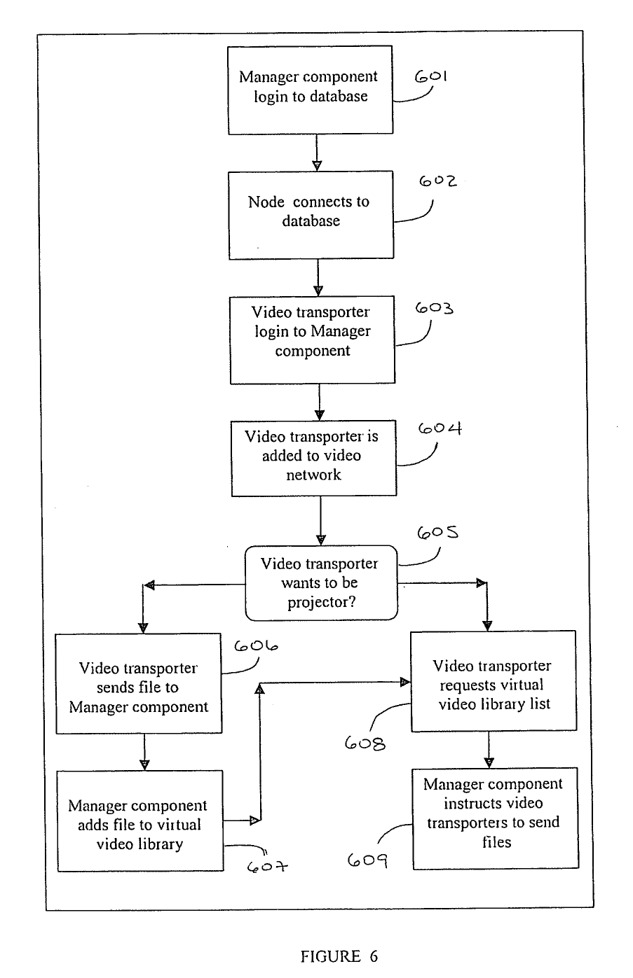

Reference is made to FIG. 6 which is a flowchart illustrating an exemplary process of building the video network. The Manager component initially registers into the database by a login process, which may also be some other form of registration process, and inputs information to the database which includes connection details of the Manager such as address and port. (Step 601). A video transporter that wants to enter the video network connects to the database and obtains the connection details of the Manager. (Step 602). Using the connection details of the Manager the node connects to the Manager and the video transporter logs in to the Manager component. During login the video transporter provides the Manager component with the node's connection details which are stored in a Manager's storage area, a memory area where needed information about a video network is stored, and which may include connection parameters of video transporters such as IP addresses, ports, and information about channels between video transporters as to who may be a sender, who may be a receiver, channel bit rate, and the like. (Step 603). The node (or video transporter, hereinafter used interchangeably) is now connected to the video network. (Step 604).

A video transporter entering video networks may serve as a projector (hosts one or more video files) and/or a viewer, in which case the video transporter wants to view the video file being broadcast through the video network. At this stage the video transporter must make a decision which subsequently must be communicated to the Manager component. (Step 605). A video transporter that wants to act as a projector sends a request to the Manager component which includes, but may not be limited to, information incorporating the node's name, address, port as well as information regarding the video to be projected, including the path to the video file on the projector's computer (hereinafter referred to as a link), file size, and other meta data. (Step 606). The Manager component manages a virtual video library wherein are stored the links to each video file managed in each video network, and which includes the link to the projector as well as the links to other nodes where the video files are stored, whether permanently or temporarily. (Step 607). The virtual video library may be part of the Manager component or may be independent of it, and may be centralized in one node or distributed among a plurality of nodes.

A video transporter which wants to act as a viewer sends a request to the manager component for a list of the video files available in the virtual video library. The viewer may also request a specific video file without having to go through the list of video files. (Step 608). The Manager component then instructs senders, which are other video transporters which are storing the video file or parts of it, whether permanently as may be in the case of the projector, or temporarily as may be the case of other viewers, to transport the file or parts of it to the requesting viewer. (Step 609). Viewers which have received authorization from the Manager component may permanently store the video file so that they may serve as projectors in the future. In circumstances where a sender suspends or stops sending a video file or a part of it, the Manager component may instruct alternate video transporters to act as senders.

3 Bandwidth Administration and Basic Transport

Prior to transmission of the video files the data may be compressed using a compression algorithm, such as a proprietary algorithm or a commercially available compression algorithm, either of which may incorporate usage restrictive measures. The encoding scheme is adaptive, and is based on the limitations and parameters of the channel in the video network and which may be custom based on user preferences.

The Manager and the Manager component, operating independently and/or jointly, act as a bandwidth administration module, sometimes referred to a bandwidth administrator, for the system described by this embodiment, and for all possible alternate embodiments which may not described in this disclosure. The bandwidth administration module, which may be used throughout this disclosure interchangeably with Manager and/or Manager component, is responsible for maximizing the bandwidth utilization to each node. The video transporters are responsible for segmenting, and the subsequent recombining and merging in real time of the video file, such that a user (at a node) may experience continuous, seemingly instantaneous viewing of video files.

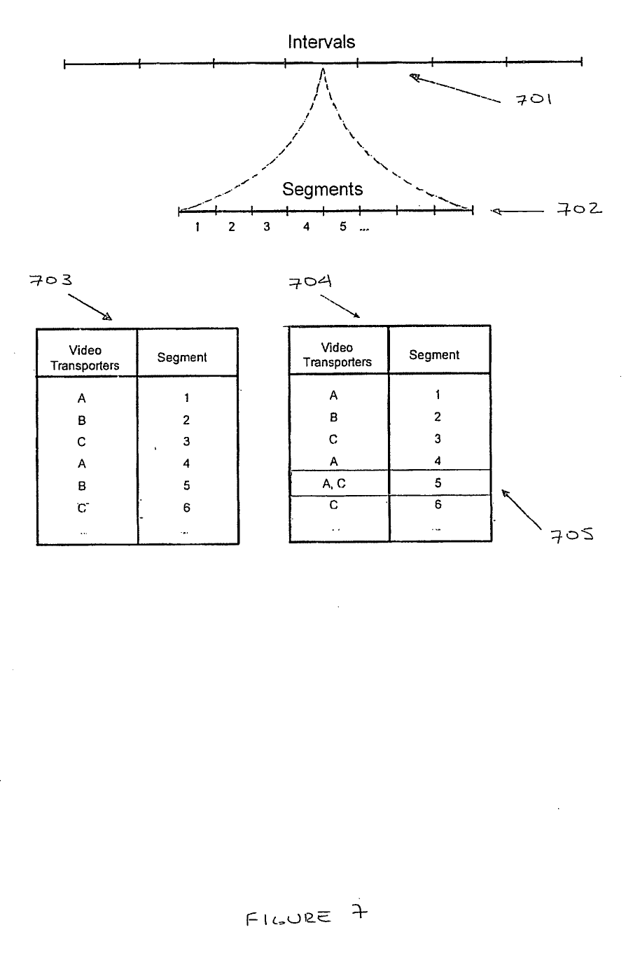

Reference is made to FIG. 7 which illustrates two exemplary transport methods depending on the state of the video network. In each of the illustrated exemplary methods three video transporters are used, although the methods may be used with multiple number of video transporter, for example 2 to 5, 5 to 50, 50 to 1000, 1000 to 10000, 10000 to 100000, 100000 to 500000, 500000 to 1000000, 1000000 to 5000000. The video file is divided into multiple intervals, for example, 20 to 200 intervals, although the file may be divided into intervals in the range of 20 to 50, 50 to 80, 80 to 110, 110 to 140, 140 to 170, 170 to 200 (Step 701). Each interval is then divided into multiple segments, for example, 20 to 200 segments, although the interval may be divided into segments in the ranges of 20 to 50, 50 to 80, 80 to 110, 110 to 140, 140 to 170, 170 to 200. (Step 702). Each interval is processed by the receiver one at a time, and in the order the intervals were derived from the video file.

Segments are sent to and from the video transporters (senders), after having undergone an encryption process to keep the data transmission as secure as possible. The video transporter is responsible for the allocation of segments to be sent, based on an allocation process which is dependent on the channel capacity. For example, video transporters A, B, and C send segments 1 to 3, and 4 to 6, respectively, in sequential order, and are received by the receiver in the same sequence. (Step 703).

In order for decisions to be made regarding what data must be sent the system maintains two cursors, a received data cursor and a video cursor. The receiver then ensures that the received data cursor is always ahead of the video cursor so as to restrict gaps in the processing. As the video cursor approaches the received data cursor, the receiver may increase the urgency for requests of segments of a certain type from the senders.

Senders send the segments upon request by the receiver. When the segments are received an acknowledgement is returned to the sender confirming receipt. Upon receipt of all the segments of an interval the receiver requests the new segments of a new interval to be transmitted. Upon reception the data is decrypted based on permission prior to being processed. This ensures the protection of the video file and proper distribution.

Every node in a video network has an upload bandwidth and a download bandwidth. Upload bandwidth is the maximum possible speed of all outgoing channels for a specific node. Download bandwidth is the maximum possible speed of all incoming channels for a specific node. The Manager, while performing the function of bandwidth administration, is responsible for maximizing bandwidth utilization throughout the system. In this process the Manager considers for each node its channel capacity, including the channel bitrate, reserve bandwidth capacity, and free bandwidth capacity, both as a sender and as a receiver. In some embodiments the system may first give priority to the free bandwidth, then use reserve bandwidth while in others, priority will be first given to the use of reserve bandwidth followed by the use of free bandwidth.

Channel bitrate is a function of the data bit rate of the video file. The timing of transmission is very important for proper processing of the data. The timing of a segment sent is influenced by two main factors, the speed of the channel and the specific request for that specific segment. If there is a specific request for a specific segment then that segment is given the highest priority and it is sent immediately. However, the normal course of operation is that the system calculates the best channel bitrate when video transporter “a” (sender) needs to send data to video transporter “b” (receiver).

For example, consider a situation where there are only two video transporters, a sender and a receiver. Assume a sender has a maximum upload bandwidth Uₐ. Also assume that a receiver has a maximum download bandwidth D_{b}. The data that needs to be transmitted has bitrate b. The channel's bitrate is v and may be calculated as follows:
v=min(Uₐ,D_{b}) Andv≧b;
The data maybe represented by multiple bitrates bₙ. If that is the case, then the system may select the data bitrate that fits the above formulas. If no b exists that fits these conditions, then no transmission can occur from video transporter “a” to video transporter “b”.

The speed of a channel is not static and may vary during transmission. These variations are influenced by changes in the state of the video network, receivers and/or senders being added or dropped from the network, or allocating their bandwidths to other purposes, or if there are problems with channels. The speed may increase or decrease, but it will always stay in the boundaries of the rule stated above.

Reserve bandwidth capacity in a channel is a function of the size of the video file and the data bit rate of the file with respect to the relative positions of the video cursor and the received data cursor. A channel's bitrate rate is variable and adjusts itself to maximize resources in the video network. If the data stream has a fixed end at the time of transmission (file with size s), then minimal speed Vₘᵢₙ is needed where:

$${V}_{min} = \frac{b ( s - r )}{( s - p )}$$

Where b is the data bitrate, s is file size, r is current position of received data cursor and p is current position of the video cursor;
For those cases where:
<r Then V_{min<}b;
And when v>Vₘᵢₙ in the channel then a reserve R in upload resources is available for the sender to use, and may be calculated as follows:
R=v−Vₘᵢₙ
This reserve may be used to send data to other video transporters on their demand. The bit rate in the old channel decreases by using reserve bandwidth.

Free bandwidth capacity is a function of the unused bandwidth in a channel The free bandwidth is unused bandwidth and therefore available for use by the sender. It may be calculated as follows:

$$F = {U}_{a} - {\sum }_{c}^{} {v}_{c}$$

Where v_{c}is the channel bitrate in every channel that sender a is sending, and Uₐ is the upload bandwidth of sender a.

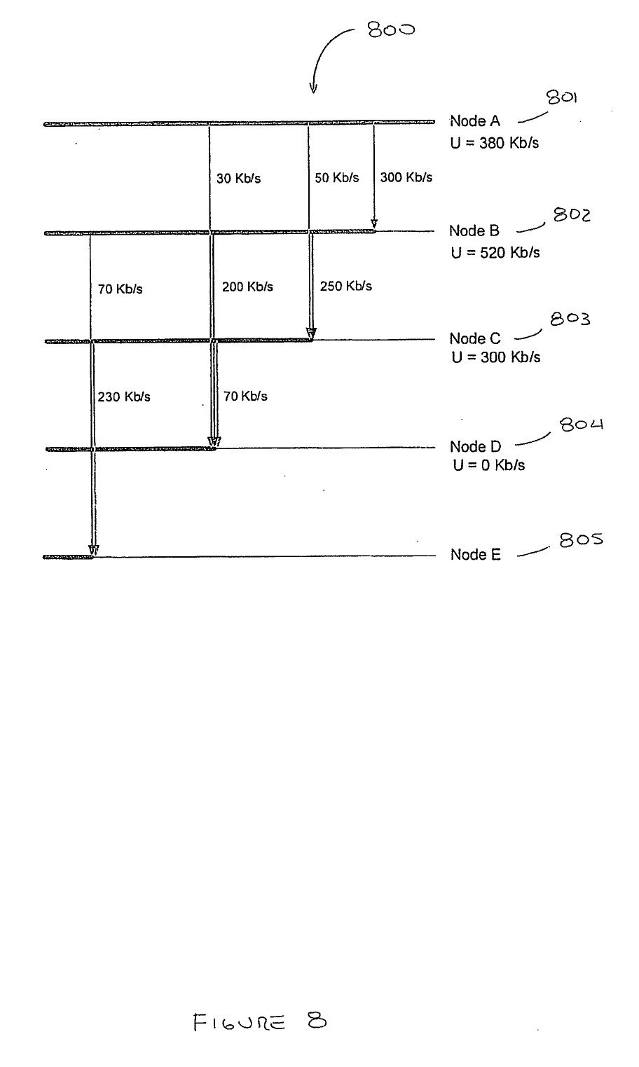

Reference is made to FIG. 8 which illustrates an exemplary process of bandwidth administration and utilization for an exemplary video network. The video network (800) shown includes five nodes, Node A (801), Node B (802), Node C (803), Node D (804) and Node E (805), but the process described may be applicable for other video networks which include numerous nodes, for example, 2 to 5, 5 to 50, 50 to 1000, 1000 to 10000, 10000 to 100000, 1000000 to 500000, 500000 to 1000000, 1000000 to 5000000.

Node A (801) is a projector, hosting a video file which requires a channel bandwidth capacity of 300 kb/s, and has a channel upload bandwidth of 380 kb/s. Node B (802), Node C (803), Node D (804) and Node E (805) are all viewers (receivers) and are assumed to have a download bandwidth (minimum 300 kb/s) suitable to handle the transmitted video file. Node B (802) receives the video file from Node A (801) which occupies 300 kb/s of Node A (801) upload bandwidth of 380 kb/s leaving Node A (801) with only 80 kb/s free upload bandwidth. Node C (803) cannot receive the complete video file from Node A (801) so it only receives a portion of it occupying 50 kb/s of the free upload bandwidth remaining in Node A (801). Node B (802) has an upload bandwidth of 520 kb/s so it is able to provide Node C (803) with the remaining portion of the video file occupying 250 kb/s of bandwidth, such that Node C (803) now receives the whole video file by combining the portions from Node A (801) and Node B (802). Node B (802) is left with 270 kb/s of free upload bandwidth to send portions of the video file to other nodes in the video network (800). Node D (804) receives portions of the video file from Node A (801) which has 30 kb/s left of free upload bandwidth, receives other portions of the video file from Node B (802) which makes available 200 kb/s of upload bandwidth for sending to Node D (804), and receives another portion of the video file from Node C (803) which makes available 70 kb/s of upload bandwidth from the 300 kb/s available. Node D (804) is now able to combine the various portions received to complete the whole video file. Node D (804) does not have any free upload bandwidth available to send the video file (or portions of it) to Node E (805). Therefore, Node B (802) sends a portion of the video file as it still has available 70 kb/s of free upload bandwidth, while Node C (803) sends the other portions required to complete the video file as it still has available 230 kb/s of free upload bandwidth.

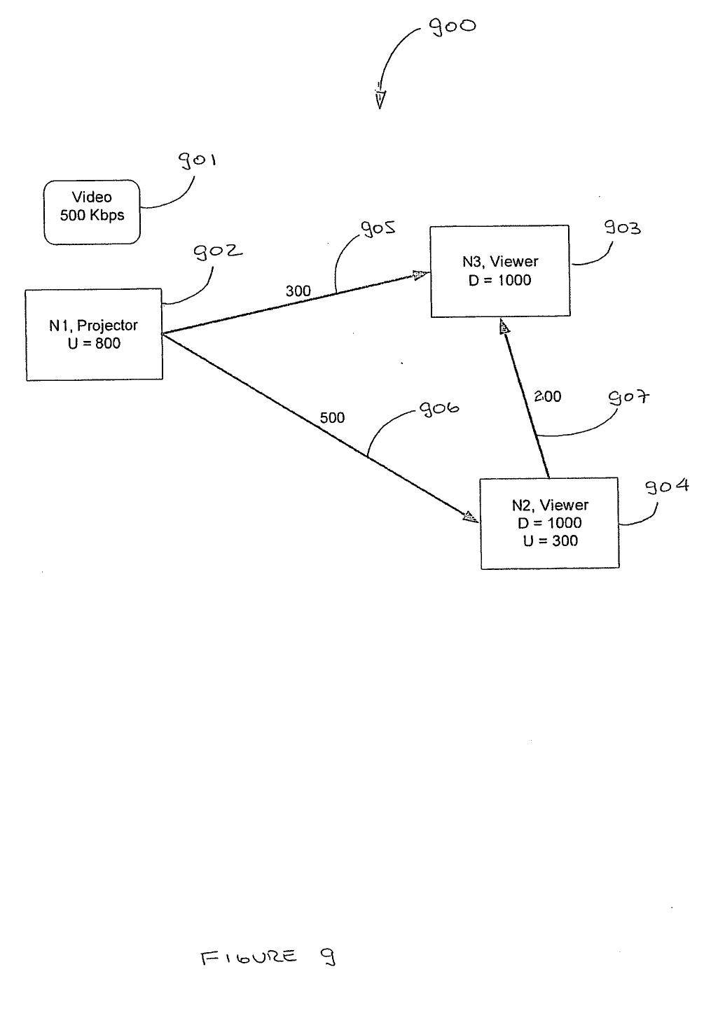

Reference is made to FIG. 9 which shows an exemplary video network in which two streams are merged in real time into one stream. The example described herein is not intended to be limiting, and is only a small sample of the numerous combinations of streams which can be merged into a stream and to the number of nodes or elements which can be interconnected in one or more video systems.

Video file (901) requires a channel bandwidth capacity of 500 kb/s for proper transmission. Node 1, Projector (902) has an upload bandwidth capacity of 800 kb/s. Node 2, Viewer (904) has a download bandwidth capacity of 1000 kb/s and an upload bandwidth capacity of 300 kb/s. Node 3, Viewer (903) has a download bandwidth of 1000 kb/s.

Node 1, Projector (902) streams the complete video file (901) to Node 2, Viewer (904), through channel 1 (906), as the video file (901) occupies 500 kb/s of the upload bandwidth capacity of 800 kb/s of Node 1, Projector (902), while still within the range of the 1000 kb/s download bandwidth capacity of Node 2, Viewer (904). This leaves Node 1, Projector with 300 kb/s free upload bandwidth to use for sending the video file (901), or segments of it, to other viewers in video network (900). Node 3, Viewer (603) wants to receive the video file (901) but is unable to receive the whole file from Node 2, Viewer (904), as the upload bandwidth of channel 2 (907) is 300 kb/s, less than the bandwidth requirements of the video file (901), which is 500 kb/s. Node 2 , Viewer (904) then streams segments of the video file (901), utilizing 200 kb/s of the free upload bandwidth capacity available of 300 kb/s. To complete the video file (901) Node 1, Projector (902) streams additional portions of the video file (901) through channel 3 (905) by utilizing the remaining free upload bandwidth capacity of 300 kb/s. The download bandwidth capacity of Node 3, Viewer is 1000 kb/s so that there is no problem receiving the segments, combining and merging the two streams to view the complete video file (901) which occupies 500 kb/s bandwidth.

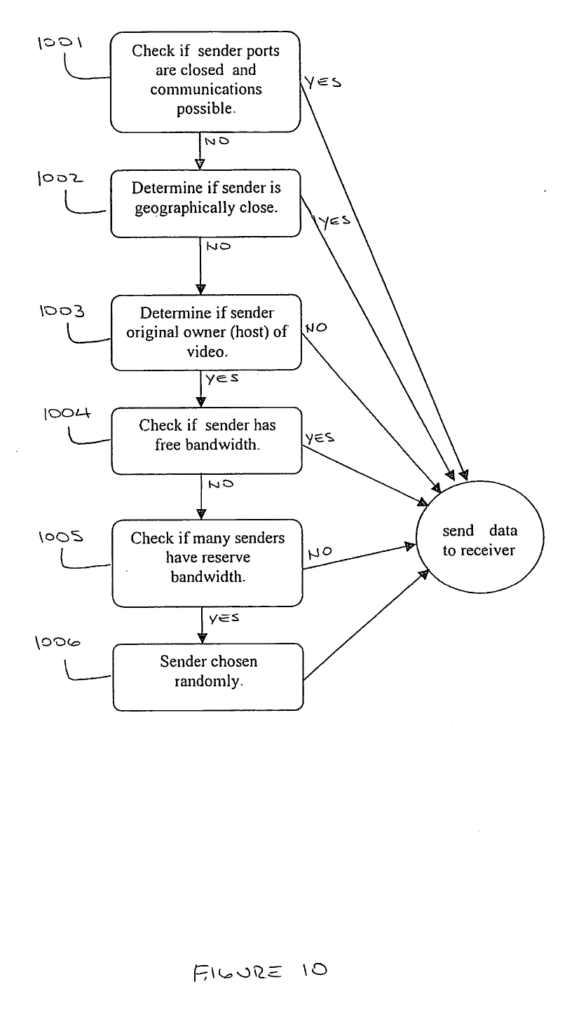

In other embodiments where multiple senders may be able to send data to a receiver, the system may use a set of rules to determine who will send the data. Reference is made to FIG. 10 which shows a flow diagram of the decision making process. The system may first determine if transmission can actually occur between two video transporters, by checking the availability of port openings via the video transporters' firewalls. (Step 1001). If the communication is possible, then priority is given to senders that are in close geographical proximity to the receiver (Step 1002), then to those senders that are not listed as original owners of the data (Step 1003), then to senders with free bandwidth (Step 1004), and finally to senders with reserve bandwidth (Step 1005). If the system has multiple senders at the end of this prioritization process, then one or more of these senders may be selected randomly (Step 1006). The following is an example:

There are in a video network a number of video transporters N₁, N₂, . . . Nₙ. A video transporter of class “a” is one that has its incoming port open. A video transporter of class “b” is one that has its incoming ports closed. It is stated that video transporters of class “b” can receive data only from video transporters of class “a”, and that video transporters of class “a” can receive data from video transporters class “a” and “b”. If a video transporter of class “b” needs data, then it receives data from “a” video transporters with free bandwidth, and then from “a” video transporters with reserve bandwidth. If a video transporter of class “a” needs data, then it receives data first from “b” video transporters with free bandwidth, then from “b” video transporters with reserve bandwidth, then from “a” video transporters with free bandwidth, and then from “a” video transporters with reserve bandwidth.

4. Advanced Transport Mechanism

Other embodiments of the present disclosure may take into consideration the possible effects of channel instability, distortions, interference and other possible variations in channel properties which may contribute to data from some senders arriving delayed to the receivers (or not arriving at all) in relation to others which arrive on time. This may result in the duplication of data arriving at the video transport receiver (or missing data) which may create an undesired situation where there are “holes” in the video in the receiving video transporter.

In order to reduce duplications and eliminate “holes” in the received video, the system may send linear combinations of the video data to the receiver. The receiver then decomposes the received data so as to reconstruct the original data from the received data.

Following is a description of the method for generating and decomposing the linear combinations of video data. For simplicity the method will first be described using as an example two senders. The later part of the description generalizes the solution to a plurality of senders.

Let there be two senders and one receiver. The data must arrive at the receiver in order and at the proper timing. The senders are not independent from one another and have knowledge of the data that has already been sent. Since the senders are sending data from a similar range or interval of data, there is a chance for duplication, and the system's goal is to reduce the duplication to a minimum so as to increase the efficiency of the transmission and to maximize the use of limited resources. At any given moment, the two senders may be filling moving intervals in a buffer of the receiving video transporters. To reduce duplicates, the receiver informs (acknowledges) its senders what segments it has already received, so that the senders do not send it again. Because of transmission delays, the acknowledge notification may not be received on time, in which case there may be duplicates. The following describes the situation:

The description of the example is a follows:
Assume S₁ is a sender that is ready to send segments X and Y to a receiver R;
Assume S₂ is a sender that also ready to send segments X and Y to the same receiver R;
Segments X and Y are of the same size;
For the transmission to be most effective every sender should send only one of the segments with no duplicates;
The first option is to do a random selection of segments (X or Y) by S₁ and S₂;
So that the probability of each segment sent is as follows:
   a. 25% segment X from S₁ and segment X from S₂;
   b. 25% segment X from S₁ and segment Y from S₂;
   c. 25% segment Y from S₁ and segment X form S₂;
   d. 25% segment Y from S₁ and segment Y from S₂.
      In this option, cases “a” and “d” above are not efficient, since both senders sent the same segment.

The other option is to use linear combinations. Instead of sending the original segment, the system sends a transformation of the segments. The transformation may be of the same size so that there is no waste in the transmission. The system may define that transformation as a linear combination. Linear combinations Z₁ and Z₂ may be defined as follows:
Z₁₌X+α₁Y
Z₂₌X+α₂Y
Where α₁, and α₂, are different random numbers. Sender S₁ sends package Z₁ and sender S₂ sends package Z₂. The plus and multiply operations above may be defined in any way, for example, according to the traditional rules of linear algebra. On the receiving end the receiver may receive two packages Z₁ and Z₂ where each has the same size as X or Y and two numbers α₁ and α₂. The length of these numbers may be very small in comparison with the length of segments. The equation may be solved as follows:

$$X = \frac{( {α}_{1} {Z}_{2} - {α}_{2} {Z}_{1} )}{( {α}_{1} - {α}_{2} )}$$

$$Y = \frac{( {Z}_{1} - {Z}_{2} )}{( {α}_{1} - {α}_{2} )} ;$$

Therefore, the receiver received unique X and Y from the two senders.

To generalize the problem to more then two senders and more then two segments which must be sent, the system may employ the following generalized definition of linear combination:

$$Z = {\sum }_{i = 1}^{N} {α}_{i} {X}_{i}$$

Where Z is the result package that every sender may send to receiver and Xᵢ is a set of original segments and αᵢ, is set of random numbers.

The decision of which segments to build the linear combination from is based on the acknowledge messages received and also based on a probability as follows:

$$p ( n ) = A exp ( - \frac{{( n - {n}_{0} )}^{2}}{{Γ}^{2}} )$$

Where n is the number of the segment in the interval which the sender is to send data to the receiver, p(n) is the probability to send segment n, n₀ is the number of first segment into interval, Γ is width of the interval, and A is a coefficient which is calculated as follow

$$A = {[ {\sum }_{n}^{} exp ( - \frac{{( n - {n}_{0} )}^{2}}{{Γ}^{2}} ) ]}^{- 1} .$$

The sender may calculate the sum according to the last formula for all video transporters which have not been received by a receiver in a selected interval (according to receiver acknowledgements), for example, every time the interval starts from first un-received video transporter into data stream.

In order to solve the system of linear equations at a receiving video transporter and to restore original segments, the system may make use of a tree structure which is a reflection of equivalent classes. An equivalence is a relation, noted with “=” between two objects which satisfies the following rules: if a=b then b=a 2) if a=b and b=c then a=c. If there is a set of objects an equivalent relation may be defined between these objects, then the full set may be divided on some subsets which are called “Equivalence classes”. This equivalence relation between segments into linear combinations which are received by a receiver may be defined as follows: segment “a” is equivalent to segment “b” if “b” may be calculated in the case when “a” is known. This may provide equivalence classes, which may be represented as tree structures in the system.

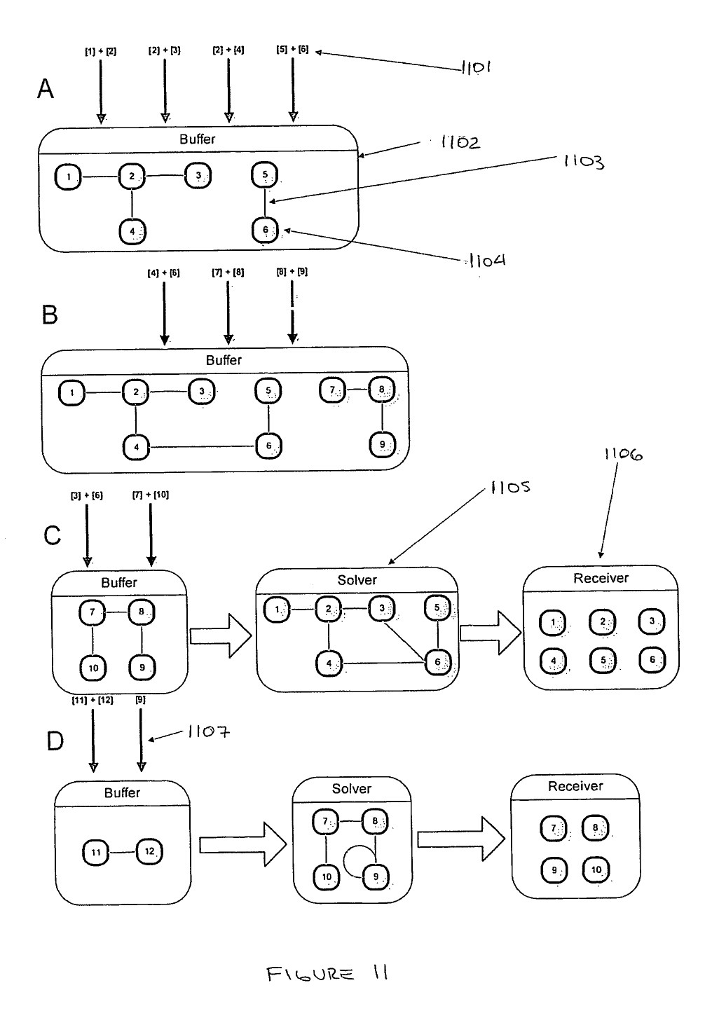

Reference is made to FIG. 11 which shows a flow diagram of an exemplary linear combination solver for an exemplary case where N=2 (where there are two segments in each linear combination). The example described herein is not intended to be limiting and is representative of the method described for the disclosed embodiment and for additional embodiments, and may apply for cases where N represents a plurality of segments and where there are a large number of linear combinations to be solved.

The exemplary linear combination solver includes elements 1101-1107 and steps A, B, C, and D. Element 1101 may represent segments of data that arrive to a receiver in the form of a linear combination. In step A there are four linear combinations; one with segments 1 & 2, one with segments 2 & 3, one with segments 2 & 4 and one with segments 5 & 6. Element 1102 may represent a memory buffer where the system holds a tree structure of the segments that arrived to the receiver. Element 1103 is a line connecting two segments and may represent in the system that the receiver received a linear combination with these two segments. Element 1104 may be a segment and the number identifies the segment ID. Element 1105 may be a process that solves the system of the linear equations. When the number of lines, or equations, is equal to the number of segments, the equations may be solved. Element 1106 may be the solved segments received by the receiver. Element 1107 may represent in the system cases where the linear combination sent may be composed of one segment only.

According to some embodiments of the present disclosure, a method for transmitting data in a communications system may include the following steps

Step A, get linear combinations 1 & 2, 2 & 3, 2 & 4 and 5 & 6. Add the segments and their line representations in a tree structure in the buffer.

Step B get the linear combinations 4 & 6, 7 & 8 and 8 & 9. Add the segments and their line representations in a tree structure in the buffer.

Step C get the linear combinations 3 & 6 and 7 & 10. Now the system can solve the equation since the solver process and the receiver now has segments 1 through 6.

Step D get the linear combinations 11 & 12 and 9. Add these segments and their line representation in a tree structure in the buffer as well Now the system can solve the equations for segments 7 through 10 and the receiver now has these segments. The process continues until all segments a have been received and processed from all senders. This same process may be repeated when there are many receivers as well. Other linear combinations, equations, segments and/or combinations of linear combinations, equations, and segments may be used.

Because the choice of segments containing in the linear combinations is random, the size of some trees may be large. To reduce memory buffer and size of linear equations (for example, to improve performance) the receiver may send a request to any sender to send a segment which appears in a large tree. When the requested original segment is received all segments contained in a large tree may be calculated.

Reference is made to FIG. 7 which illustrates two exemplary transport methods depending on the state of the video network. An embodiment of this disclosure addresses the exemplary case in which the data transmission between the video transponders is uninterrupted and the communication lines are stable. If however the transmission is not stable, some video transporters complete their job before others. If such is the case, the video transporters A and C will send data (Step 704) to fill out segment 5 (Step 705), thereby combining two streams in real time to fill out one segment via linear combinations.

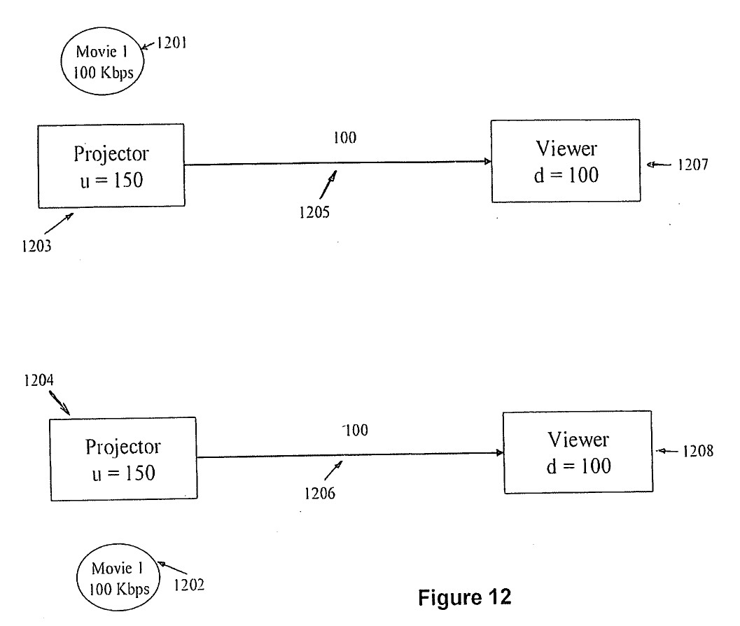

Reference is made to FIG. 12 which shows two projectors (1203,1204) with upload bandwidth of 150 kbps each transmitting the same video (1201, 1202) to two viewers (1207, 1208) without a stream combination and merging option. Projector (1203) transmits the video to viewer (1207) via channel (1205) which is enough for streaming the video file at a bitrate of 100 kbps. Projector (1204) transmits the video to viewer (1208) via channel (1206) which is enough for streaming the video file at a bitrate of 100 kbps. Available Bandwidth is the bandwidth of a node in excess of its current capacity for transmission. It is equal to the Reserve bandwidth plus the Free bandwidth. The available bandwidth (free bandwidth plus reserve bandwidth) in the video network is equal to 100 kbps, 50 kbps of which come from projector (1203) and 50 kbps come from (1204). By combining the two streams from projector (1203) and projector (1204), it is possible to extend the video (1201, 1202) reach to another one viewer on this example.

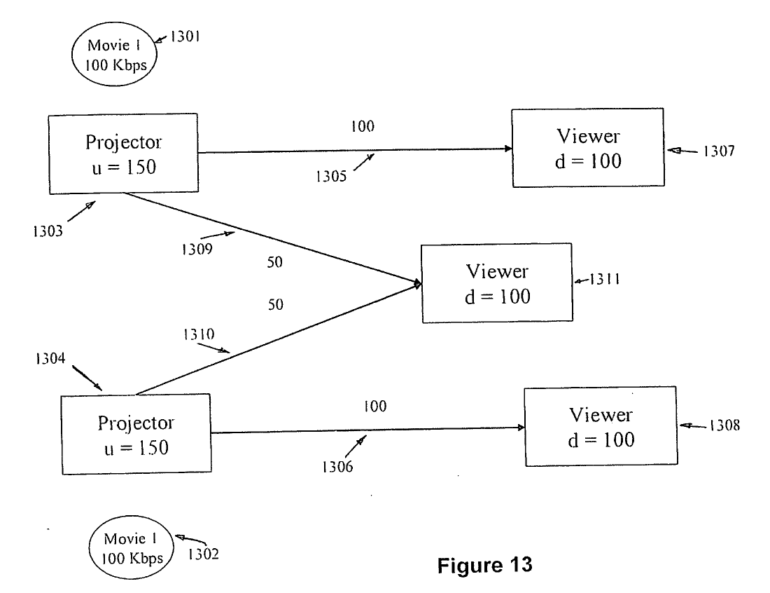

FIG. 13 shows the effect of combining and merging streams. In this example two projectors (1303, 1304) with upload bandwidth of 150 kbps each are transmitting the same video (1301, 1302) to three viewers (1307, 1308, 1311). Projector (1303) transmits the video to viewer (1307) via channel (1305) which is enough for streaming the video file at bitrate of 100 kbps. Projector (1304) transmits the video to viewer (1308) via channel (1306) which is enough for streaming the video file at bitrate of 100 kbps. In addition, both projectors (1303, 1304) transmit the video to a new viewer (1311) by combining streams in real time so that the viewer (1311) watches the video properly and in real time. Projector (1303) transmits the video (1201) to viewer (1311) at 50 kbps, and projector (1304) transmits the video (1202) to viewer (1311) also at 50 kbps. Together this is enough for viewer (1311) to watch the video as one combined video stream.

Combining and merging streams in real time provides the ability to extend the reach of a video network. Video reach is the number of receivers that receive video transmission in real time in the video network. Extended video reach (EVR) is the number of additional receivers that can participate in a video network and receive a real-time stream as a result of combining the available bandwidth of multiple transmitters Given some transmitters transmitting a video with bitrate b, and given total available bandwidth of the transmitters is equal U, then the extended video reach is equal to the integer part of U divided by b.

An embodiment of the present disclosure is described in the Provisional Application titled A Method And System For Realtime Media Streaming, dated 20 Sep. 2005, which is incorporated herein in its entirety by reference.

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope

What we claim is:

1-28. (canceled)

29. A real-time transmitter comprising:
a bandwidth administration module adapted to regulate content transmission between one or more transmitters and one or more receivers, and to, further regulate content retransmission from one or more receivers.

30. The transmitter according to claim 29, wherein said bandwidth administration module is adapted to instruct one or more nodes to create one or more transport channels.

31. The transmitter according to claim 29, wherein said bandwidth administration module is adapted to assign one or more nodes to send data based on available communication options between two or more nodes.

32. The transmitter according to claim 29, wherein said bandwidth administration module is adapted to identify a disabled node and to rebuild one or more transport channels around the said disabled node.

33. The transmitter according to claim 29, wherein said bandwidth administration module is adapted to dynamically add one or more new nodes to the content network.

34. The transmitter according to claim 29, wherein said bandwidth administration module is transferable to another node.

35. The transmitter according to claim 29, wherein said bandwidth administration module is adapted to regulate content transmission and retransmission such that content data rates received are at or above a minimum data rate associated with the content.

36. The transmitter according to claim 29, wherein said bandwidth administration module is adapted to instruct one or more nodes to communicate at a calculated speed based on the bandwidth of one or more nodes, and based on fluctuations in bandwidth.

37. The transmitter according to claim 29, wherein said content comprises of a media content.

38. The transmitter according to claim 37, wherein said media content comprises a video content.

39. The transmitter according to claim 29, further comprising a communication module adapted to transmit content to one or more receivers based on an initiative of said communication module, or based on a request from one or more receivers.

40. The transmitter according to claim 39, wherein said communication module is adapted to transmit a transformation of one or more content segments.

41. The transmitter according to claim 39, wherein said communication module is adapted to decide what content to transmit based on one or more acknowledge messages.

42. A real-time transmitter comprising:
a bandwidth administration module adapted to regulate content transmission between one or more transmitters and one or more receivers, and to further regulate content retransmission from one or more receivers; and
a communication module adapted to transmit content to one or more receivers based on based on an initiative of said communication module, or based on one or more requests from one or more receivers, said transmitter is further adapted to be regulated based on one or more signals from a bandwidth administration module.

43. The transmitter according to claim 42, wherein said bandwidth administration module is adapted to instruct one or more nodes to create one or more transport channels.

44. The transmitter according to claim 42, wherein said bandwidth administration module is adapted to assign one or more nodes to send data based on available communication options between two or more nodes.

45. The transmitter according to claim 42, wherein said bandwidth administration module is adapted to identify a disabled node and to rebuild one or more transport channels around the said disabled node.

46. The transmitter according to claim 42, wherein said bandwidth administration module is adapted to dynamically add one or more new nodes to the content network.

47. The transmitter according to claim 42, wherein said bandwidth administration module is transferable to another node.

48. The transmitter according to claim 42, wherein said bandwidth administration module is adapted to regulate content transmission and retransmission such that content data rates received are at or above a minimum data rate associated with the content.

49. The transmitter according to claim 42, wherein said bandwidth administration module is adapted to instruct one or more nodes to communicate at a calculated speed based on the bandwidth of one or more nodes, and based on fluctuations in bandwidth.

50. The transmitter according to claim 42, wherein said content comprises of a media content.

51. The transmitter according to claim 50, wherein said media content comprises a video content.

52. The transmitter according to claim 42, wherein said communication module is adapted to transmit a transformation of one or more content segments.

53. The transmitter according to claim 42, wherein said communication module is adapted to decide what content to transmit based on one or more acknowledge messages.

54. A real-time receiver comprising:
communication module adapted to receive content from one or more sources based on one ore more signals from a bandwidth administration module, said communication module is further adapted to retransmit received content to one or more destinations based on one ore more signals from said bandwidth administration module.

55. The receiver according to claim 54, wherein said communication module is adapted to combine content streams from two or more sources in real time.

56. The receiver according to claim 54, wherein said communication module is adapted to minimize the duplication of content received.

57. The receiver according to claim 54, wherein said communication module is adapted to receive content in the proper sequence as associated with the content.

58. The receiver according to claim 54, wherein said communication module is adapted to process received partial content.

59. The receiver according to claim 54, wherein said communication module is adapted to send one or more requests for content to one or more transmitters.

60. The receiver according to claim 54, wherein said communication module is adapted to translate a transformed content sent from one or more transmitters.

61. The receiver according to claim 54, wherein said communication module is adapted to send an acknowledge message for received content to one or more transmitters.

62. The receiver according to claim 54, further adapted to function as a transmitter.

63. The receiver according to claim 54, further comprising a bandwidth administration module adapted to regulate content transmission between one or more transmitters and one or more receivers, and to further regulate content retransmission from one or more receivers.

64. The receiver according to claim 63, wherein said bandwidth administration module is adapted to instruct one or more nodes to create one or more transport channels.

65. The receiver according to claim 63, wherein said bandwidth administration module is adapted to assign one or more nodes to send data based on available communication options between two or more nodes.

66. The receiver according to claim 63, wherein said bandwidth administration module is adapted to identify a disabled node and to rebuild one or more transport channels around the said disabled node.

67. The receiver according to claim 63, wherein said bandwidth administration module is adapted to dynamically add one or more new nodes to the content network.

68. The transmitter according to claim 63, wherein said bandwidth administration module is transferable to another node.

69. The receiver according to claim 63, wherein said bandwidth administration module is adapted to regulate content transmission and retransmission such that content data rates received are at or above a minimum data rate associated with the content.

70. The transmitter according to claim 63, wherein said bandwidth administration module is adapted to instruct one or more nodes to communicate at a calculated speed based on the bandwidth of one or more nodes, and based on fluctuations in bandwidth.

71. The receiver according to claim 63, wherein said content comprises of a media content.

72. The receiver according to claim 71, wherein said media content comprises a video content.

73. A real-time receiver comprising:
a communication module adapted to receive content from one or more sources based on one ore more signals from a bandwidth administration module, said communication module is further adapted to retransmit received content to one or more destinations based on one or more signals from said bandwidth administration module; and
a bandwidth administration module adapted to regulate content transmission between one or more transmitters and one or more receivers, and to further regulate content retransmission from one or more receivers.

74. The receiver according to claim 73, wherein said communication module is adapted to combine content streams from two or more sources in real time.

75. The receiver according to claim 73, wherein said communication module is adapted to minimize the duplication of content received.

76. The receiver according to claim 73, wherein said communication module is adapted to receive content in the proper sequence as associated with the content.

77. The receiver according to claim 73, wherein said communication module is adapted to process received partial content.

78. The receiver according to claim 73, wherein said communication module is adapted to send one or more requests for content to one or more transmitters.

79. The receiver according to claim 73, wherein said communication module is adapted to translate a transformed content sent from one or more transmitters.

80. The receiver according to claim 73, wherein said communication module is adapted to send an acknowledge message for received content to one or more transmitters.

81. The receiver according to claim 73, further adapted to function as a transmitter.

82. The receiver according to claim 73, wherein said bandwidth administration module is adapted to instruct one or more nodes to create one or more transport channels.

83. The receiver according to claim 73, wherein said bandwidth administration module is adapted to assign one or more nodes to send data based on available communication options between two or more nodes.

84. The receiver according to claim 73, wherein said bandwidth administration module is adapted to identify a disabled node and to rebuild one or more transport channels around the said disabled node.

85. The receiver according to claim 73, wherein said bandwidth administration module is adapted to dynamically add one or more new nodes to the content network.

86. The transmitter according to claim 73, wherein said bandwidth administration module is transferable to another node.

87. The receiver according to claim 73, wherein said bandwidth administration module is adapted to regulate content transmission and retransmission such that content data rates received are at or above a minimum data rate associated with the content.

88. The transmitter according to claim 73, wherein said bandwidth administration module is adapted to instruct one or more nodes to communicate at a calculated speed based on the bandwidth of one or more nodes, and based on fluctuations in bandwidth.

89. The receiver according to claim 73, wherein said content comprises of a media content.

90. The receiver according to claim 89, wherein said media content comprises a video content.

91. A system comprising:
a real time bandwidth administration module adapted to regulate content transmission between one or more transmitters and one or more receivers, and to further regulate content retransmission from one or more receivers;
a real time transmitter adapted to transmit content to one or more receivers based on an initiative of said communication module, or based on one or more requests from one or more receivers, said transmitter is further adapted to be regulated based on one or more signals from a bandwidth administration module: and
a real time receiver adapted to receive content from one or more sources based on signals from a bandwidth administration module, said communication module is further adapted to retransmit received content to one or more destinations based on one or more signals from said bandwidth administration module.

92. The system according to claim 91, wherein said bandwidth administration module is adapted to instruct one or more nodes to create one or more transport channels.

93. The system according to claim 91, wherein said bandwidth administration module is adapted to assign one or more nodes to send data based on available communication options between two or more nodes.

94. The system according to claim 91, wherein said bandwidth administration module is adapted to identify a disabled node and to rebuild one or more transport channels around the said disabled node.

95. The system according to claim 91, wherein said bandwidth administration module is adapted to dynamically add one or more new nodes to the content network.

96. The transmitter according to claim 91, wherein said bandwidth administration module is transferable to another node.

97. The system according to claim 91, wherein said bandwidth administration module is adapted to regulate content transmission and retransmission such that content data rates received are at or above a minimum data rate associated with the content.

98. The system according to claim 91, wherein said bandwidth administration module is adapted to instruct one or more nodes to communicate at a calculated speed based on the bandwidth of one or more nodes, and based on fluctuations in bandwidth.

99. The system according to claim 91, wherein said content comprises of a media content.

100. The system according to claim 99, wherein said media content comprises a video content.

101. The system according to claim 91, wherein said transmitter is adapted to transmit a transformation of one or more content segments.

102. The system according to claim 91, wherein said transmitter is adapted to decide what content to transmit based on one or more acknowledge messages.

103. The system according to claim 91, wherein said receiver is adapted to combine content streams from two or more sources in real time.

104. The system according to claim 91, wherein said receiver is adapted to minimize the duplication of content received.

105. The system according to claim 91, wherein said receiver is adapted to receive content in the proper sequence as associated with the content.

106. The system according to claim 91, wherein said receiver is adapted to process received partial content.

107. The system according to claim 91, wherein said receiver is adapted to send one or more requests for content to one or more transmitters.

108. The system according to claim 91, wherein said receiver is adapted to translate a transformed content sent from one or more transmitters.

109. The system according to claim 91, wherein said receiver is adapted to send an acknowledge message for received content to one or more transmitters.

110. The system according to claim 91, further adapted to function as a transmitter.
